(19) United States
(12) Patent Application Publication
(10) Pub. No.: US 2023/0317090 A1
(43) Pub. Date: Oct. 5, 2023

(54) VOICE CONVERSION DEVICE, VOICE CONVERSION METHOD, PROGRAM, AND RECORDING MEDIUM

(71) Applicant: DWANGO CO., LTD., Tokyo (JP)

(72) Inventors: Kazuyuki HIROSHIBA, Tokyo (JP); Yuri ODAGIRI, Tokyo (JP); Shinya KITAOKA, Tokyo (JP)

(73) Assignee: DWANGO CO., LTD., Tokyo (JP)

(21) Appl. No.: 18/043,105

(22) PCT Filed: Jun. 1, 2022
(86) PCT No.: PCT/JP2022/022364

§ 371 Date: Feb. 27, 2023

(30) Foreign Application Priority Data
Jun. 30, 2021 (JP) 2021-108707

(51) Int. Cl. G10L 21/013; G10L 21/04; G10L 15/02

(52) U.S. Cl. CPC G10L 21/013; G10L 21/04; G10L 15/02; G10L 2021/0135; G10L 2015/025

(57) ABSTRACT

A voice conversion apparatus includes: an input unit that inputs designation of a conversion destination voice; an extraction unit that analyzes a voice signal of a conversion source voice and extracts time series data including a phoneme and a pitch; an adjustment unit that matches a height of the pitch to a height of the designated conversion destination voice; and a generation unit that inputs the phoneme and the pitch to a deep learning model that learns voice data of many people and is capable of synthesizing a designated person's voice in time-series order, and generates a voice signal obtained by synthesizing the designated conversion destination voice.

### FIELD

The present invention relates to a voice conversion apparatus, a voice conversion method, a program, and a recording medium.

### BACKGROUND

With spread of a service for distributing videos in which a computer graphics character (hereinafter, referred to as an avatar) is manipulated in a virtual space, there is a demand for voice conversion that matches an appearance of the avatar. For example, even in a case where the sex and the age of a distributor who operates the avatar do not match the appearance of the avatar, a distributor's voice is desirable to be converted into a voice that matches the appearance of the avatar.

The quality of voice synthesis including the voice conversion has been greatly improved due to advance in deep learning technologies over the past few years. Among the technologies, due to a deep learning model WaveNet that incorporates a method called autoregression that generates a voice sample little by little, it is possible to synthesize a voice with almost the same quality as in an actual voice. WaveNet has a weakness of slow synthesis speed while having high synthesis quality, and thus a model such as WaveRNN that improves the weakness also has appeared.

### CITATION LIST

### Patent Literature

PTL 1: JP6783475B2

### SUMMARY

As a voice conversion method using deep learning, there is a method of performing voice conversion by preparing pair data of voices of the same sentence read by a conversion source voice and a conversion destination voice, and by setting the pair data as training data. However, since it is necessary to record a voice by causing a person of a conversion source voice to read a plurality of sentences and it is necessary to perform deep learning with the voice data, the method has a problem that a lot of time is taken. The reason why the voice data of the conversion source is necessary in the deep learning of the voice conversion is that the voice conversion is intended to be solved directly (end-to-end) by the deep learning.

In addition, there is a demand for avatars with the same appearance to speak with the same voice. That is, it is desired that anyone's voice can be converted into the same voice. Furthermore, in a case where anyone's voice can be converted into voices of various people's voices, a distributor can select a desired voice as an avatar's voice or a plurality of avatars can be operated by one or a small number of distributors.

The invention has been made in consideration of such circumstances, and an object thereof is to convert anyone's voice into various people's voices.

According to an aspect of the invention, there is provided a voice conversion apparatus including: an input unit that inputs designation of a conversion destination voice; an extraction unit that analyzes a voice signal of a conversion source voice and extracts time series data including a phoneme and a pitch; an adjustment unit that matches a height of the pitch to a height of the designated conversion destination voice; and a generation unit that inputs the phoneme and the pitch to a deep learning model that learns voice data of many people and is capable of synthesizing a designated person's voice in time-series order, and generates a voice signal obtained by synthesizing the designated conversion destination voice.

According to another aspect of the invention, there is provided a voice conversion method causing a computer to: input designation of a conversion destination voice; analyze a voice signal of a conversion source voice and extract time series data including a phoneme and a pitch; match a height of the pitch to a height of the designated conversion destination voice; and input the phoneme and the pitch to a deep learning model that learns voice data of many people and is capable of synthesizing a designated person's voice in time-series order, and generate a voice signal obtained by synthesizing the designated conversion destination voice.

According to the invention, anyone's voice can be converted into various people's voices.

### BRIEF DESCRIPTION OF DRAWINGS

FIG. 1 is a view illustrating an example of a configuration of a voice conversion apparatus of an embodiment.

FIG. 2 is a view illustrating height adjustment of a pitch.

FIG. 3 is a view illustrating a deep learning model of the voice conversion apparatus.

FIG. 4 is a view illustrating a state in which voice conversion is possible without limiting a conversion source voice.

FIG. 5 is a flowchart illustrating an example of a processing flow by the voice conversion apparatus.

FIG. 6 is a view illustrating an example of a configuration of a modification example of the voice conversion apparatus of this embodiment.

FIG. 7 is a view illustrating an example of a screen of a Web application using the voice conversion apparatus.

FIG. 8 is a view illustrating an example of a configuration in which a speed conversion device is connected to the voice conversion apparatus.

### DETAILED DESCRIPTION

[Configuration]

Hereinafter, an embodiment of the invention will be described with reference to the accompanying drawings.

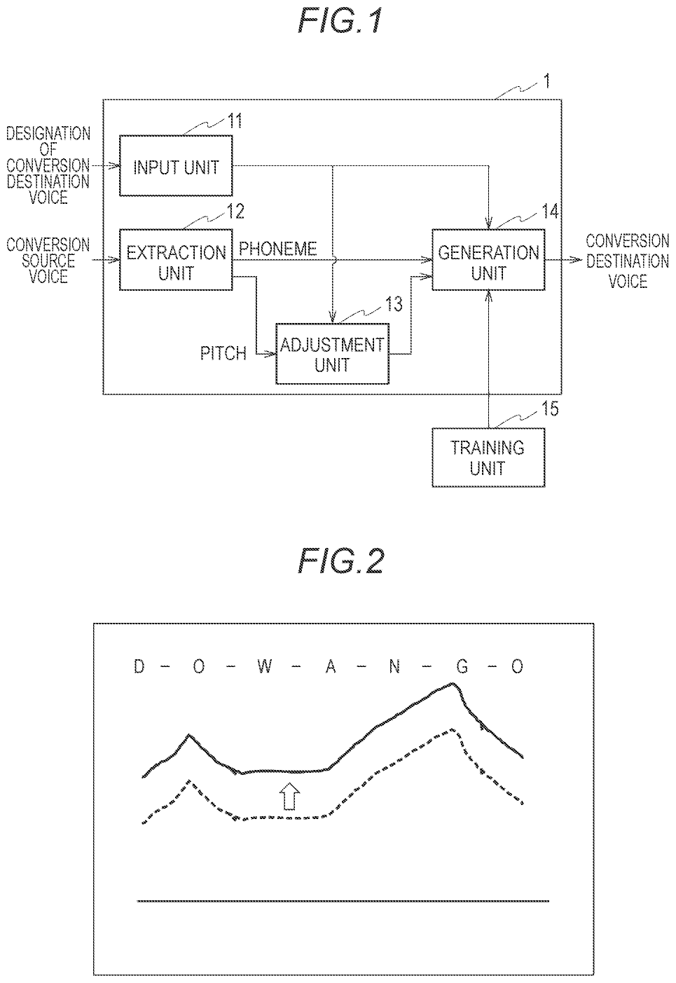

An example of a configuration of a voice conversion apparatus 1 of this embodiment will be described with reference to FIG. 1. The voice conversion apparatus 1 illustrated in FIG. 1 includes an input unit 11, an extraction unit 12, an adjustment unit 13, and a generation unit 14. The respective units provided in the voice conversion apparatus 1 may be constituted by a computer including an operation processing device, a storage device, and the like, and processing of each of the units may be executed by a program. The program is stored in the storage device provided in the voice conversion apparatus 1, and can be recorded in a recording medium such as a magnetic disk, an optical disc, and a semiconductor memory, or can be provided through a network.

The input unit 11 inputs designation of a conversion destination voice. For example, the input unit 11 may input an identifier or a name of the conversion destination voice, or may input an attribute (a sex, an adult voice, a child voice, a high voice, a low voice, or the like) of the conversion destination voice. In a case where the attribute of the conversion destination voice is input, the input unit 11 selects a conversion destination voice corresponding to the attribute among candidates of the conversion destination voice.

The extraction unit 12 inputs a voice signal (hereinafter, referred to as voice data) of the conversion source voice, recognizes the conversion source voice, and extracts time-series data including phonemes (consonant+vowel) from the conversion source voice and a pitch with respect to each of the phonemes. The pitch also includes voice information such as an intonation, an accent, and a voice duration. The extraction unit 12 may scan a file in which the voice data is recorded, may input the voice data by using a microphone (not illustrated) provided in the voice conversion apparatus 1, or may input the voice data from a device that is connected to an external terminal provided in the voice conversion apparatus 1. The extraction unit 12 extracts phonemes and pitches from the voice data by an existing voice recognition technology. For example, OpenJTalk can be used in extraction of the phonemes, and WORLD can be used in extraction of the pitches. Note that, the number of the phonemes is determined by the content of the voice data (the content of a text), and the number of the pitches is determined by a length of the voice data, and thus the phonemes and the pitches may not correspond to each other in a one-to-one relationship.

The extraction unit 12 may input voice data and a sentence of a closed content in combination with the voice data. The extraction unit 12 may extract the phonemes from the input sentence, or may correct a voice recognition result of the voice data by the input sentence. When both the voice and the sentence are input, reading accuracy of the phonemes and acquisition of pitch information are realized. For example, in a case where wrong phonemes are recognized due to a poor tongue, or the like, adjustment can be performed by the input sentence.

The extraction unit 12 transmits the phonemes to the generation unit 14 in time-series order, and transmits the pitches to the adjustment unit 13. The pitches are transmitted to the generation unit 14 after performing height adjustment by the adjustment unit 13.

As illustrated in FIG. 2, the adjustment unit 13 performs linear conversion with respect to a pitch for every phoneme extracted by the extraction unit 12, and matches a height of a conversion source voice to a height of a conversion destination voice. For example, the adjustment unit 13 converts a low voice to a high voice, or converts a high voice to a low voice. Note that, the height of the conversion destination voice is known already, and is stored in a storage device provided in the voice conversion apparatus 1. The adjustment unit 13 calculates an average of heights of voices for every conversion destination voice, and may adjust an average of heights of conversion source voices to the average of the heights of the conversion destination voice.

The generation unit 14 inputs the phoneme and the pitch after conversion to a deep learning model that is trained by voice data of many people, and synthesizes a voice signal that is uttered by the conversion destination voice designated by the input unit 11. The deep learning model that is retained in the generation unit 14 outputs a voice signal that is uttered by a voice designated by the input unit 11 when a phoneme and a pitch are input. As the deep learning model, for example, WaveRNN can be used. When extracting phonemes from conversion source voice data, an utterance section of each of the phonemes is extracted and is attached to the phoneme, and the phoneme and the pitch are input to the generation unit 14. Accordingly, the generation unit 14 can output a voice that keeps the utterance section of the conversion source voice data. With regard to a voiceless section, the voiceless section may be input to the generation unit 14, and a voiceless section of the same duration may be output.

The voice conversion apparatus 1 may include a training unit 15. The training unit 15 extracts phonemes and pitches from many people's voice data serving as the conversion destination voice, and trains a deep learning model that can synthesize voices of many person which are extraction sources from the phonemes and the pitches. For example, in this embodiment, the training unit 15 trains a deep learning model that synthesizes a voice of a designated person among 100 professional speakers and outputs the voice when phonemes and pitches are extracted from a JVS corpus that is high-quality voice data obtained from the 100 professional speakers and the phonemes and the pitches are input. Due to deep learning of voices of many speakers, even when voice data of each speaker is small, a voice of each speaker can be synthesized with good quality.

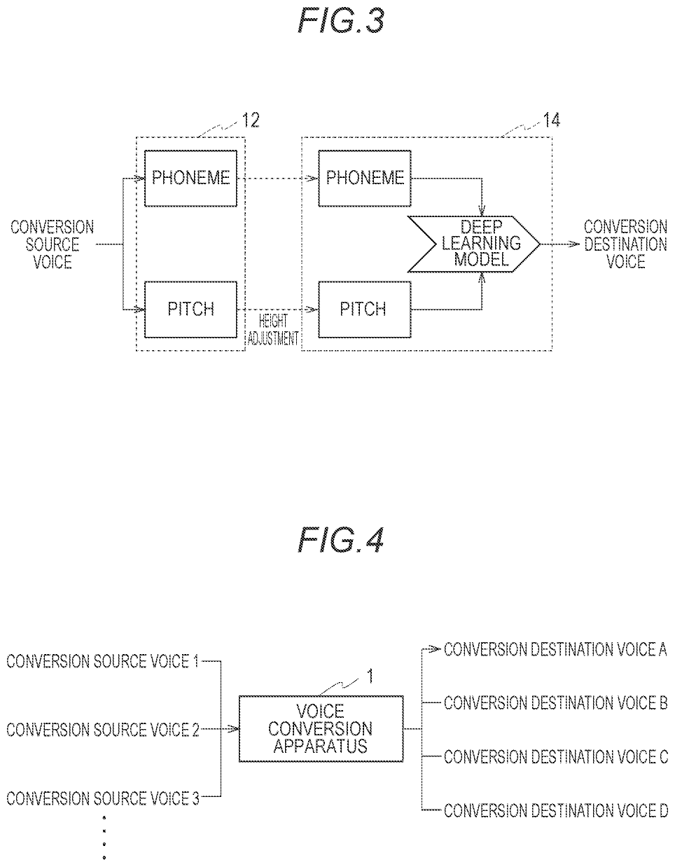

As described above, in this embodiment, the conversion source voice is decomposed into elements which do not depend on speakers, and the conversion destination voice is synthesized from the decomposed elements, and thus voice conversion in which a waveform of the conversion source voice is not converted can be realized. Specifically, as illustrated in FIG. 3, in the voice conversion, phonemes are extracted as language information from voice data, pitches and utterance timing are extracted as non-language information, the phonemes and the pitches which are extracted are input to the deep learning model, and voice synthesis of the conversion destination voice is performed.

In this embodiment, since the conversion source voice is decomposed into elements which do not depend on a speaker, and voice synthesis is performed, it is not necessary to learn pair data of the conversion source voice and the conversion destination voice, and as illustrated in FIG. 4, voice conversion into many person's voices used in learning can be performed even from anyone's voice.

[Operation]

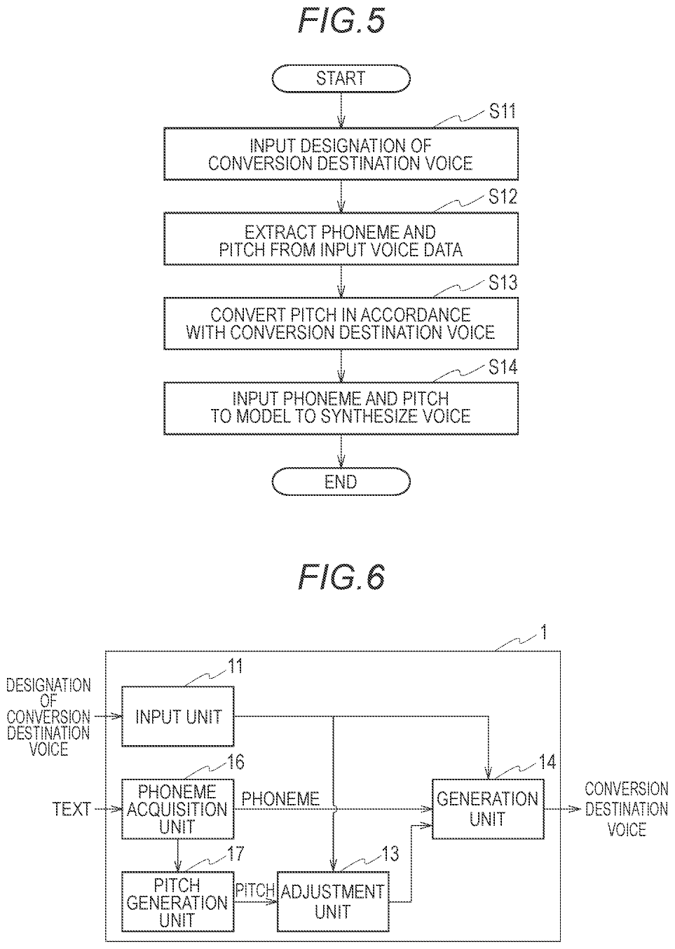

Next, a voice conversion operation by the voice conversion apparatus 1 will be described with reference to a flowchart in FIG. 5.

In step S11, the voice conversion apparatus 1 inputs designation of the conversion destination voice.

In step S12, the voice conversion apparatus 1 inputs voice data of the conversion destination voice, and extracts phonemes and pitches from the voice data.

In step S13, the voice conversion apparatus 1 converts the pitches extracted in step S12 in accordance with the conversion destination voice.

In step S14, the voice conversion apparatus 1 inputs the phonemes and the converted pitches to the deep learning model, and synthesizes and outputs the conversion destination voice. When outputting voices of a plurality of people, processing in step S13 and step S14 is repeated, and a plurality of conversion destination voices are synthesized.

[Modification Example]

Next, description will be given of an example of a configuration of a modification example of the voice conversion apparatus 1 according to this embodiment with reference to FIG. 6. A voice conversion apparatus 1 illustrated in FIG. 6 includes the input unit 11, the adjustment unit 13, the generation unit 14, a phoneme acquisition unit 16, and a pitch generation unit 17. The voice conversion apparatus 1 illustrated in FIG. 6 is different from the voice conversion apparatus 1 illustrated in FIG. 1 in that the phoneme acquisition unit 16 and the pitch generation unit 17 are provided instead of the extraction unit 12, and a text is input instead of the voice data, and a vice signal of a designated conversion destination voice is output.

The input unit 11 inputs designation of the conversion destination voice.

The phoneme acquisition unit 16 inputs the text, and acquires phonemes from the input text. For example, the phoneme acquisition unit 16 morphologically analyzes the input text to generate a voice symbol string that expresses the voice with character codes, and acquires phonemes from the voice symbol string. The phoneme acquisition unit 16 maintains accent information of words or the like, and when acquiring the phonemes from the text, gives an instruction for the pitch generation unit 17 to generate pitches based on the accent.

The pitch generation unit 17 generates the pitches corresponding to the phonemes. For example, the pitch generation unit 17 stores standard pitches in the storage device, and reads and outputs pitches corresponding to a designated accent.

The adjustment unit 13 matches the pitches generated by the pitch generation unit 17 to pitches of the conversion destination voice.

The generation unit 14 inputs the phoneme and the pitches after linear conversion to the deep learning model, and synthesizes a voice signal uttered by a conversion destination voice designated by the input unit 11.

[Examples]

Next, description will be given of examples using the voice conversion apparatus 1 of this embodiment.

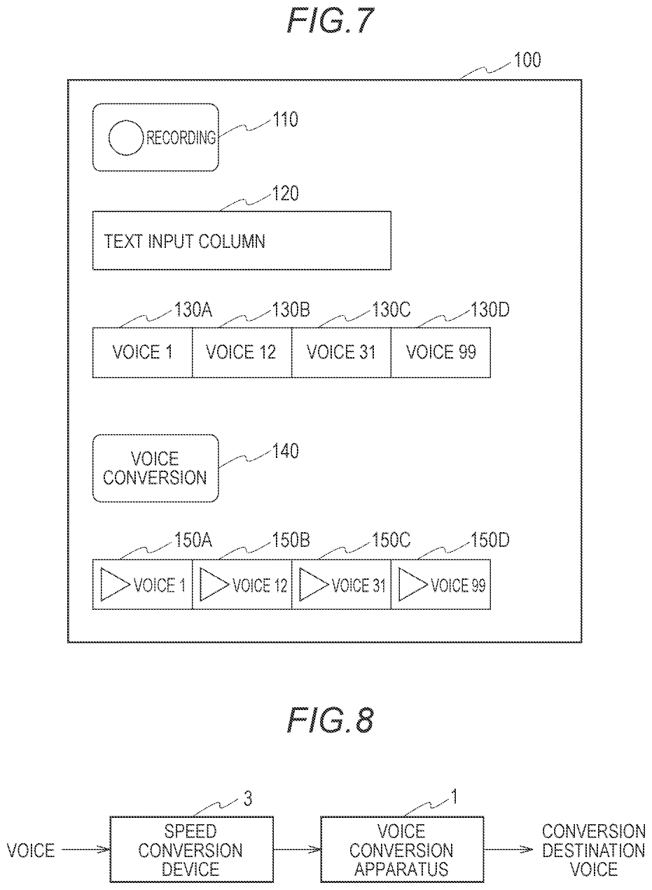

FIG. 7 is a view illustrating an example of a screen 100 of a Web application that converts a voice into voices of a plurality of people when the voice is input. For example, when a user accesses a Web site that provides a voice conversion service with a browser of a portable terminal or a personal computer (PC), a screen 100 in FIG. 7 is displayed.

A recording button 110, a text input column 120, conversion destination voice labels 130A to 130D, a voice conversion button 140, and conversion destination voice reproduction buttons 150A to 150D are arranged within the screen 100.

A user presses the recording button 110 and inputs a voice from a microphone connected to the portable terminal or the PC. According to this, voice data of the user's voice is recorded.

The user inputs a sentence with the same content as in the recorded voice to the text input column 120. For example, in a case where the user records “hello”, the user inputs “hello” to the text input column 120. The sentence with the same content as in the voice recorded by the user may be automatically input to the text input column 120 by using a voice recognition function of the portable terminal or the PC.

Labels representing a conversion destination voice are displayed in the conversion destination voice labels 130A to 130D. In the example in FIG. 7, labels of “voice 1”, “voice 12”, “voice 31”, and “voice 99” are displayed. This represents conversion into voices of persons of No. 1, No. 12, No. 31, and No. 99. The conversion destination voice may be determined in advance, or may be randomly selected. Alternatively, the user may select the conversion destination voice.

When the user presses the voice conversion button 140, voice conversion processing is initiated. Specifically, recorded voice data, the sentence input to the text input column 120, and voice identifiers displayed in the conversion destination voice labels 130A to 130D are input to the voice conversion apparatus 1. The voice conversion apparatus 1 extracts phonemes and pitches from the voice data, and also extracts phonemes from the sentence. The voice conversion apparatus 1 may correct the phonemes extracted from the voice data with the phonemes extracted from the sentences, or may use the phonemes extracted from the sentences in subsequent processing. The voice conversion apparatus 1 performs height adjustment of pitches and voice synthesis with respect to each of conversion destination voices displayed in the conversion destination voice labels 130A to 130D, and outputs voice data obtained by converting a user's voice into each of the conversion destination voices.

After the voice conversion, when the user presses each of the conversion destination voice reproduction buttons 150A to 150D, voice data of a voice corresponding to each of the conversion destination voice reproduction buttons 150A to 150D is reproduced.

Next, description will be given of an example in which the voice conversion apparatus of this embodiment is used in voice speed conversion. In a case of using the voice conversion apparatus 1 in the voice speed conversion, the input unit 11 accepts reproduction speed designation, and the extraction unit 12 compresses or expands time-series data including phonemes and pitches extracted by the extraction unit 12 in a time direction, and inputs the time-series data to the generation unit 14. For example, in a case of reproduction at a double speed, an utterance section of the phonemes extracted by the extraction unit 12 is compressed, and the adjustment unit 13 compresses the pitches in the time direction, and then adjusts the pitches to a height of a conversion destination voice and inputs the phonemes and the pitches to the generation unit 14. According to this, an input voice is reproduced at a double with a voice quality without uncomfortable feeling (conversion destination voice). As the conversion destination voice, any voice may be selected. When selecting a voice close to a conversion source voice as the conversion destination voice, a voice reproduction speed can be changed with less uncomfortable feeling. In a case of slowly reproducing the input voice, the utterance section of the phoneme is expanded, and the pitches may be simultaneously expanded in the time direction.

FIG. 8 illustrates an example in which a speed conversion device 3 is connected to the voice conversion apparatus 1. The speed conversion device 3 inputs a voice (may also be a moving image), and performs fast reproduction or a slow reproduction by changing a reproduction speed of an input voice. In the voice in which the reproduction speed is changed, pitches vary, and become high or low.

When inputting a voice in which a reproduction speed is changed (pitches are changed) to the voice conversion apparatus 1, the voice conversion apparatus 1 extracts phonemes and pitches from voice data in which the reproduction speed is changed, linearly converts the extracted pitches into a height of the conversion destination voice, and inputs the phonemes and the pitches to the deep learning model to synthesize a voice in accordance with the conversion destination voice. According to this, a voice in which the pitches are changed due to change of the reproduction speed is reproduced with the conversion destination voice at utterance timing after change of the reproduction speed. Note that, when inputting a content of a voice to be input to the voice conversion apparatus 1 and closed text data, it is possible to compensate a decrease in a recognition rate of the voice reproduced fast.

In FIG. 8, the voice conversion apparatus 1 and the speed conversion device 3 are configured by individual devices, but the voice conversion apparatus 1 may have the function of the speed conversion device 3. In addition, even in a case where the speed conversion device 3 is not provided, when inputting a voice reproduced at a double speed or slowly to the voice conversion apparatus 1, the voice can be converted into a natural voice with a typical pitch while maintaining the speed at the double speed or the slow speed.

As described above, the voice conversion apparatus 1 of this embodiment includes the input unit 11 that inputs designation of the conversion destination voice, the extraction unit 12 that analyzes a voice signal of the conversion source voice and extracts time series data including a phoneme and a pitch, the adjustment unit 13 that matches a height of the pitch to a height of the designated conversion destination voice, and the generation unit 14 that inputs the phoneme and the pitch to the deep learning model that learns voice data of many people and is capable of synthesizing a designated person's voice in time-series order, and generates a voice signal obtained by synthesizing the designated conversion destination voice. In this embodiment, the conversion source voice is decomposed into phonemes and pitches which do not depend on a speaker, and the conversion destination voice is synthesized with the phonemes and the pitches. Accordingly, voice conversion that does not convert a waveform of the conversion source voice can be realized. According to this, when training the deep learning model that performs voice synthesis with the phonemes and the pitches, anyone's voice can be converted into the conversion destination voice without using conversion source voice data.

### REFERENCE SIGNS LIST

1: voice conversion apparatus

11: input unit

12: extraction unit

13: adjustment unit

14: generation unit

15: training unit

16: phoneme acquisition unit

17: pitch generation unit

3: speed conversion device

1-8. (canceled)

9. A voice conversion apparatus, comprising:
an input unit that inputs designation of a conversion destination voice;
an extraction unit that analyzes voice data of a conversion source voice and extracts time series data including a phoneme and a pitch;
an adjustment unit that matches a height of the pitch to a height of the designated conversion destination voice; and
a generation unit that inputs the phoneme and the pitch to a deep learning model that learns voice data of many people and is capable of synthesizing a designated person's voice in time-series order, and generates voice data obtained by synthesizing the designated conversion destination voice.

10. The voice conversion apparatus according to claim 9, further comprising:
a training unit that extracts phonemes and pitches from many people's voice data which become conversion destination voices, and trains a deep learning model capable of synthesizing each of the many people's voices from the phonemes and the pitches.

11. The voice conversion apparatus according to claim 9,
wherein the extraction unit inputs the same sentences as in an utterance content of the conversion source voice in combination with the voice data of the conversion source voice, and analyzes the sentence to extract phonemes.

12. The voice conversion apparatus according to claim 9,
wherein the extraction unit extracts phonemes by analyzing a sentence instead of the voice data of the conversion source voice, reads out pitches corresponding to the phonemes from a storage device, and transmits the pitches to the adjustment unit.

13. The voice conversion apparatus according to claim 9,
wherein the extraction unit extracts an utterance section of each of the phonemes, and inputs the utterance section that is compressed or expanded to the generation unit, and
the adjustment unit compresses or expands the pitches in a time direction in accordance with the compression or expansion of the utterance section.

14. A voice conversion method causing a computer to:
input designation of a conversion destination voice;
analyze voice data of a conversion source voice and extract time series data including a phoneme and a pitch;
match a height of the pitch to a height of the designated conversion destination voice; and
input the phoneme and the pitch to a deep learning model that learns voice data of many people and is capable of synthesizing a designated person's voice in time-series order, and generate voice data obtained by synthesizing the designated conversion destination voice.

15. A recording medium that records a program causing a computer to execute:
processing of inputting designation of a conversion destination voice;
processing of analyzing voice data of a conversion source voice and extracting time series data including a phoneme and a pitch;
processing of matching a height of the pitch to a height of the designated conversion destination voice; and
processing of inputting the phoneme and the pitch to a deep learning model that learns voice data of many people and is capable of synthesizing a designated person's voice in time-series order, and generating voice data obtained by synthesizing the designated conversion destination voice.
